(19) United States
(12) Patent Application Publication
(10) Pub. No.: US 2014/0353338 A1
(43) Pub. Date: Dec. 4, 2014

(54) Removal device for a crop protection agent

(71) Applicants: Robert Huber, Limburgerhof (DE); Karl-Heinz Koch, Kapellen-Drusweiler (DE); Harald Kroeger, Boehl-Iggelheim (DE); Heinz-Gerd Wegkamp, Lampertheim (DE); Christian-Andreas Winkler, Mannheim (DE)

(72) Inventors: Robert Huber, Limburgerhof (DE); Karl-Heinz Koch, Kapellen-Drusweiler (DE); Harald Kroeger, Boehl-Iggelheim (DE); Heinz-Gerd Wegkamp, Lampertheim (DE); Christian-Andreas Winkler, Mannheim (DE)

(73) Assignee: BASF SE, Ludwigshafen (DE)

(21) Appl. No.: 14/363,433

(22) PCT Filed: Dec. 5, 2012
(86) PCT No.: PCT/EP2012/074454

§ 371 Date: Jun. 6, 2014

(30) Foreign Application Priority Data
Dec. 9, 2011 (EP) 11192860.2

(51) Int. Cl. A01M 7/00

(52) U.S. Cl. CPC A01M 7/0032
USPC 222/318; 222/464.2; 222/464.7; 222/377; 222/382

(57) ABSTRACT

The present invention relates to a discharge apparatus for a plant protection product with a container (1) which encloses an interior (7) for accommodating the plant protection product and which comprises a discharge orifice (9). The discharge apparatus according to the invention is characterized by a suction tube (3) which comprises a first orifice (10) in the interior (7) of the container (1), a second orifice (5) at the discharge orifice (9) of the container (1) and a third orifice (4) in the interior (7) of the container (1), which third orifice (4) is arranged at a distance from the first orifice (10), and a pump (2), which is in particular arranged in the interior (7) of the container (1) and is in operative connection with the suction tube (3), such that plant protection product located in the container (1) may be delivered by means of the pump through the suction tube (3) from the first orifice (10) of the suction tube to the second and the third orifices (5, 4) of the suction tube (3). The invention further relates to the use of such a discharge apparatus for discharging a plant protection product which is located in the interior (7) of the container (1).

The present invention relates to a discharge apparatus for a plant protection product. The discharge apparatus comprises a container which encloses an interior for accommodating the plant protection product and which comprises a discharge orifice.

Plant protection product containers are known in which the plant protection product is discharged through the discharge orifice by rotating the container manually such that the discharge orifice is arranged at the bottom. A line may then be connected to the discharge orifice and the plant protection product escapes through the discharge orifice under the effect of gravity.

A drawback of such plant protection product containers is that, in the case of those plant protection products which have a tendency to sediment out, the sediments are not discharged from the plant protection product container at a constant concentration. Instead, plant protection product volumes containing more sediment particles are initially discharged while at the end plant protection product volumes containing fewer sediment particles are discharged. While it is indeed possible to homogenize the plant protection product in the container before discharge by manually shaking the container, such shaking demands considerable effort and becomes impossible for relatively large and heavy containers. If a plant protection product container contains more than 15 l of plant protection product, manually shaking the container is at best possible only with severe difficulty.

It is furthermore known to discharge the plant protection product from relatively large containers by means of a pump. To this end, the discharge orifice is connected via a hose to the pump which, from the outside, aspirates the plant protection product located in the interior of the container. Here too, however, the problem arises that plant protection products with a tendency to sediment out are not homogenized during discharge.

The object of the present invention is accordingly to provide a discharge apparatus for a plant protection product in which the plant protection product may be homogenized before discharge.

Said object is achieved according to the invention by a discharge apparatus having the features of claim 1. Advantageous embodiments and further developments are revealed by the dependent claims.

The discharge apparatus according to the invention for a plant protection product comprises a container which encloses an interior for accommodating the plant protection product and which comprises a discharge orifice. The discharge apparatus furthermore comprises a suction tube which comprises a first orifice in the interior of the container and a second orifice at the discharge orifice of the container. The suction tube additionally comprises a third orifice in the interior of the container which is arranged at a distance from the first orifice. The discharge apparatus moreover comprises a pump which is in operative connection with the suction tube, such that plant protection product located in the container may be delivered by the pump through the suction tube from the first orifice of the suction tube to the second and the third orifices of the suction tube. The suction tube of the discharge apparatus thus comprises an orifice at which the plant protection product in the interior of the container enters the suction tube. It additionally comprises an orifice via which the plant protection product may be discharged, i.e. conveyed out of the container. However, the suction tube additionally comprises a further third orifice, at which the plant protection product, which has been aspirated via the first orifice, emerges back into the interior of the container. It is in this way advantageously ensured that the plant protection product is agitated or circulated in the interior of the container, whereby sedimentation of the contents is avoided or any contents which have formed a sediment are agitated and homogeneously distributed.

In the discharge apparatus according to the invention, the pump is in particular incorporated into the discharge apparatus. It is preferably arranged in the interior of the container. This ensures that the plant protection product accommodated in the interior of the container does not pass out of and back into the interior, so preventing contamination of the plant protection product in the exterior space outside the container. If, on the other hand, the pump were arranged outside the container and were optionally detachable from the container and if the plant protection product were conveyed out of the container and back into the container through a further orifice, the entirety of the plant protection product located in the interior of the container would be at risk of contamination. Moreover, the pump located in the interior of the container cannot be used in conjunction with another plant protection product container optionally containing another plant protection product. In the discharge apparatus according to the invention, there is accordingly no risk of the discharged plant protection product being contaminated by a contaminated pump.

According to one development of the discharge apparatus according to the invention, the container comprises a base and the first orifice of the suction tube is arranged in the interior of the container in the region of the base of the container. In this case, the suction tube acts as a dip tube. The plant protection product may be discharged when the container is oriented such that the base is arranged at the bottom. There is no need to rotate the container such that the discharge orifice points downwards. In the discharge apparatus according to the invention, the discharge orifice is instead arranged on the opposite side of the container from the base, i.e. at the top.

The positioning of the first orifice relative to the base of the container is selected such that the first orifice is located as close as possible to the base of the container, so as to minimize the residual volume which can no longer be aspirated via the first orifice because the first orifice is no longer completely in the liquid plant protection product. On the other hand, however, the first orifice is arranged relative to the base such that entry of the liquid plant protection product into the suction tube via the first orifice is not impeded.

The distance of the first orifice from the base may depend in particular on the viscosity of the plant protection product which is intended to be accommodated in the container.

For example, plant protection products having a low viscosity are used, i.e. in particular liquids having a viscosity of no more than 50 mPa·s, in particular no more than 30 mPa·s, for example 0.5 to 50 mPa·s, in particular 0.8 to 20 mPa·s (determined by Brookfield rotational viscometry to DIN 53019 (ISO 3219) at 25° C. and with a shear gradient of 100 s⁻¹). At a low viscosity, the plant protection product can be aspirated very easily. The first orifice can therefore be arranged very close to the base of the container.

However, it is also possible to use plant protection products which are gel-like fluids. Gel-like fluids have an increased viscosity compared with the fluids of low viscosity. Such gel-like fluids are generally viscoelastic and generally have at 25° C. a zero shear viscosity η0 of at least 100 mPa·s and in particular at least 200 mPa·s. However, the dynamic viscosity of the gel-like fluid will not generally exceed a value of 1000 mPa·s, in particular 500 mPa·s and especially 300 mPa·s (determined by Brookfield rotational viscometry to DIN 53019 (ISO 3219) at 25° C. and with a shear gradient of 100 s⁻¹) and lies in particular in the range of from 30 to 1000 mPa·s, frequently in the range of from 30 to 800 mPa·s and in particular in the range of from 50 to 500 mPa·s. In order to ensure that the plant protection product is drawn into the suction tube, in this case the first orifice should be arranged at least further away from the base of the container than in the case of a plant protection product having a low viscosity.

According to one development of the discharge apparatus according to the invention, the base of the container is formed such that it has a lowest point. The first orifice is then arranged in the region of the lowest point of the base. The lowest point represents, in particular with respect to the height, a minimum in the base, with the base dropping monotonically in the direction of the lowest point, in particular dropping strictly monotonically. There are thus also no local plateaus above the lowest point.

To this end, the container can be formed for example in a parabolic, conical or funnel-shaped manner. The base of the container can be formed such that the lowest point is located on one side of the container. The base then extends from the lowest point obliquely upwards to the other side of the container in a manner rising strictly monotonically. As a result of these developments, the residual liquid advantageously collects at the lowest point of the container. The residual volume which can no longer be aspirated through the first orifice is thus minimized.

The first orifice can in particular also touch the base of the container, irrespective of whether the base is formed horizontally or with a lowest point. In order then to make it possible for plant protection product to be able to be aspirated, the suction tube in this case has at the lower end holes, which then form the first orifice and through which the plant protection product can pass. The size of these holes then depends in particular on the viscosity of the plant protection product, it being possible for larger holes to be used for more viscous plant protection products and smaller holes for less viscous plant protection products.

According to a further development of the discharge apparatus according to the invention, the third orifice of the suction tube is arranged in the upper region of the container. The third orifice is in particular arranged relative to the first orifice such that they are as far apart as possible. This ensures that, when the plant protection product is delivered from the first orifice through the suction tube to the third orifice, the plant protection product located in the interior of the container is circulated and agitated as well as possible. The third orifice of the suction tube is, however, arranged relative to the internal wall of the container such that the emergence of the plant protection product through the third orifice is not impeded. The third orifice may for example be arranged adjacent to the discharge orifice of the container, but is located in the interior of the container.

In particular, the third orifice is located in the upper third of the height of the container. However, the third orifice is preferably arranged in an upper range of 90% to 100% of the height of the container. If the third orifice is arranged at 100% of the height, this means that the upper edge of the third orifice butts against the internal wall of the upper wall of the container. However, the third orifice is particularly preferably arranged just under the upper wall of the container. By way of such an arrangement of the third orifice, the distance between the first orifice arranged at the base of the container and the third orifice is particularly large. Specifically, if the third orifice is arranged too low in the container, it is possible that the plant protection product will circulate for example only in the lower third between the two orifices. There would then be little blending with the plant protection product in the upper region. In particular, “dead points” could also form, at which there is no circulation at all. As a result of the return of plant protection product into the container from a third orifice which is arranged as high up as possible, these dead points are minimized. As a result, the plant protection product is circulated and agitated in a particularly effective manner.

Furthermore, in particular not only is the vertical distance between the first and third orifices particularly large, but also the horizontal distance between these orifices. One orifice can be arranged on one side of the container and the other orifice on the other side of the container.

The second orifice of the suction tube is for example connected to the discharge orifice or the suction tube passes through the discharge orifice such that the second orifice is located outside the container. In this case, the suction tube is accommodated in a leakproof manner in the discharge orifice of the container, such that the plant protection product can only escape via the second orifice of the suction tube and not via the gap between the edge of the discharge orifice and the outer wall of the suction tube.

The suction tube comprises a branch to the third orifice, in particular between the first orifice and the second orifice. According to one development of the discharge apparatus according to the invention, a valve, in particular a pressure relief valve, is arranged between the branch and the third orifice. This ensures that, when the pump is in operation, the plant protection product is circulated in the interior of the container if no plant protection product can emerge via the second orifice of the suction tube because, for example, the second orifice or a downstream device for passage of the plant protection product is closed.

According to a further development of the discharge apparatus according to the invention, the latter further comprises an output device. Said output device may for example be a spray gun via which the plant protection product may be sprayed. The output device comprises an inlet orifice and an output orifice. A suitable nozzle may for example be provided at the output orifice. The inlet orifice is connected to the second orifice of the suction tube or to the discharge orifice of the container, such that the plant protection product may be delivered via this orifice into the output device.

A shut-off valve is in particular arranged between the inlet orifice and the output orifice of the output device. The shut-off valve may be closed and opened for example by a suitable mechanical trigger. When the shut-off valve is closed, operation of the pump aspirates the plant protection product at the first orifice of the suction tube, delivers it through the suction tube and outputs it back into the interior of the container at the third orifice of the suction tube. The pump may thus also be operated when the shut-off valve of the output device is closed. In this case, the plant protection product is recirculated in the interior of the container, so homogenizing the plant protection product and preventing sedimentation.

When the shut-off valve is open, the pump aspirates the plant protection product at the first orifice of the suction tube, delivers it through the suction tube and delivers it into the output device at the second orifice of the suction tube. The plant protection product then passes through the output device and is output at the output orifice of the output device.

The present invention further relates to the use of the above-described discharge apparatus for discharging a plant protection product which is located in the interior of the container. The discharge apparatus according to the invention is in particular suitable for discharging liquid plant protection products. The discharge apparatus according to the invention is in particular suitable for discharging liquid plant protection products with a tendency to sediment out. The discharge apparatus according to the invention may for example be used in conjunction with liquid plant protection products formulated as EC, EW, SC, ME, SE or OD. Liquid plant protection products which have a tendency to sediment out are above all those which are formulated as SC, SE or OD. These types of formulation are familiar to a person skilled in the art, and described for example in H. Mollet, A. Grubenmann “Formulation Technology”, WILEY-VCH, Weinheim 2001, pp. 389-397 and literature cited therein.

An EC is understood by a person skilled in the art to be a liquid plant protection product formulation in which the plant protection active ingredient(s) are present as a homogeneous solution in an organic solvent or solvent mixture immiscible with water, the solution producing an emulsion when diluted with water.

An EW is understood by a person skilled in the art to be a liquid plant protection product formulation in which the plant protection active ingredient(s) are present in the form of an oil-in-water emulsion, at least one of the plant protection active ingredients being present in the oil droplets.

An SC is understood by a person skilled in the art to be a liquid plant protection product formulation in which the plant protection active ingredient(s) are present in the form of solid, finely divided particles, which are suspended in an aqueous coherent phase. These formulations are also known as suspension concentrates.

An ME is understood by a person skilled in the art to be a liquid plant protection product formulation in which the plant protection active ingredient(s) are present in the form of a microemulsion, typically at least one of the plant protection active ingredients typically being dissolved in the organic phase.

An OD is understood by a person skilled in the art to be a liquid plant protection product formulation in which the plant protection active ingredient(s) are present in the form of solid, finely divided particles, which are suspended in a non-aqueous coherent phase. These formulations are also known as oil dispersion concentrates.

An SE is understood by a person skilled in the art to be a liquid plant protection product formulation in which the plant protection active ingredient(s) are present in the form of solid, finely divided particles, which are suspended in a non-aqueous liquid phase, which is in turn emulsified in an aqueous phase. These formulations are also known as suspo-emulsion concentrates.

In addition to one or more preferably organic plant protection active ingredients and at least one aqueous or non-aqueous diluent, the above-stated formulations generally comprise at least one surface-active substance, which is frequently selected from among anionic and non-ionic emulsifiers and from among anionic and non-ionic polymeric dispersion auxiliaries and which serves to form stable suspensions or emulsions when the formulation is diluted with water and, in the case of multiphasic liquid formulations such as EW, SC, ME, OD or SE, serves to stabilize the phases. The formulations optionally comprise “adjuvants”, which improve the efficacy of the plant protection product(s). Furthermore, the formulations generally comprise one or more additives, such as additives for modifying rheological properties, anti-freeze agents, colorants, and biocides in the quantities conventional for the respective formulation type.

The invention will now be explained with the aid of an exemplary embodiment and with reference to the figures.

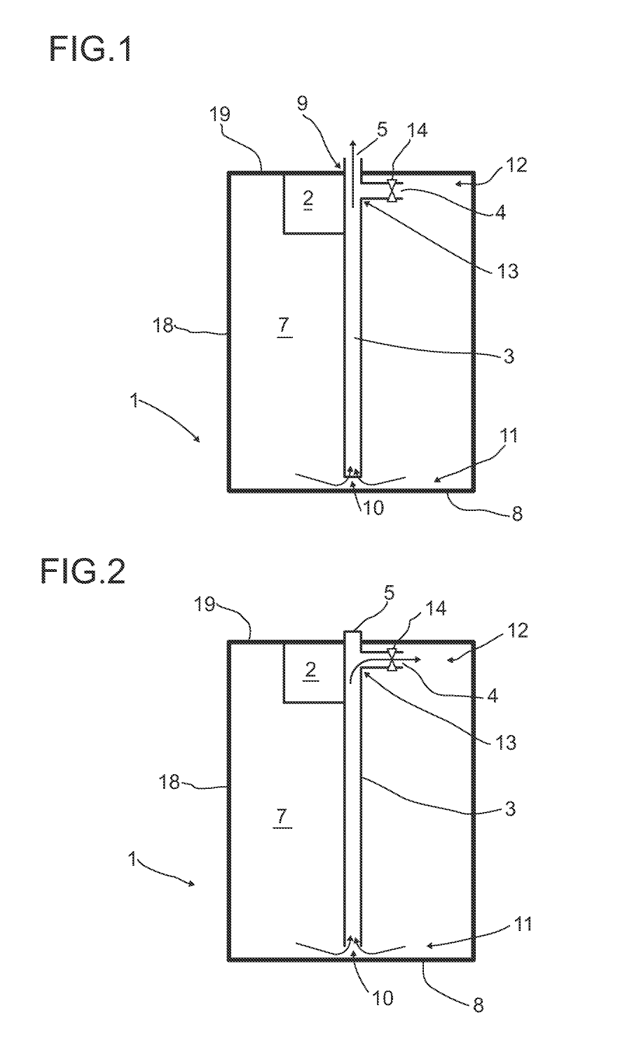

FIG. 1 shows a diagrammatic sectional representation of an exemplary embodiment of the discharge apparatus according to the invention in a first state,

FIG. 2 shows a diagrammatic sectional representation of the exemplary embodiment of FIG. 1 in a second state,

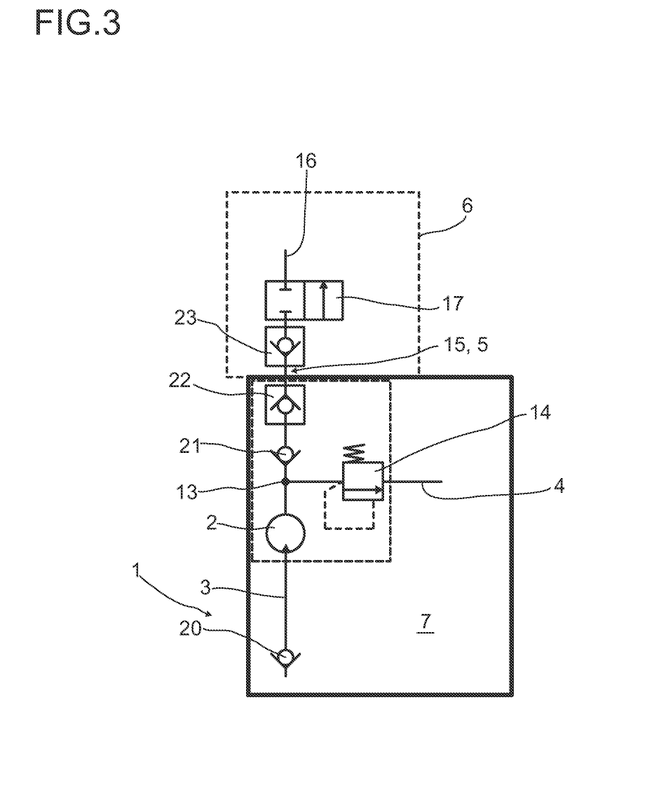

FIG. 3 shows a circuit diagram of an exemplary embodiment of the discharge apparatus according to the invention including the output device,

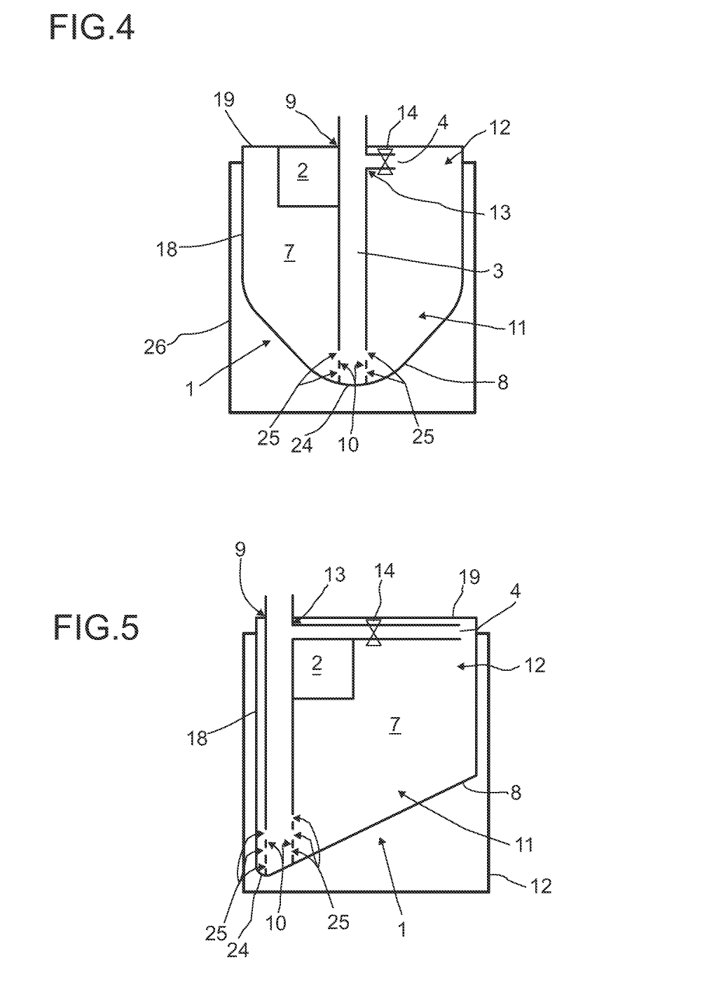

FIG. 4 shows a diagrammatic sectional representation of a second exemplary embodiment of the discharge apparatus according to the invention, and

FIG. 5 shows a diagrammatic sectional representation of a third exemplary embodiment of the discharge apparatus according to the invention.

The discharge apparatus comprises a container 1 which comprises an interior 7, a base 8, side walls 18 and an upper wall 19. The upper wall 19 comprises a discharge orifice 9. The plant protection product is accommodated in the interior 7 of the container 1.

A suction tube 3 is located within the discharge apparatus. The suction tube 3 comprises a first orifice 10 which is arranged in the lower region 11 adjacent to the base 8 of the container 1. The first orifice 10 is located as close as possible to the base 8. It is, however, located at such a distance from the base 8 that the liquid plant protection product may enter the suction tube 3 unimpeded via the orifice 10. The distance of the first orifice 10 from the base 8 may for example depend on the viscosity of the plant protection product which is to be accommodated by the container 1.

The suction tube 3 extends upwards from the first orifice 10 in the vicinity of the base 8 of the container 1. It passes out through the upper wall 19, emerging from the container 1 through the discharge orifice 9. The suction tube 3 is here accommodated in a leakproof manner in the discharge orifice 9. Outside the container 1, the suction tube 3 comprises a second orifice 5. As is explained below, a connector for a line, a hose or an output device is provided at said second orifice 5.

According to another exemplary embodiment, the suction tube 3 does not pass through the discharge orifice 9 of the container 1. The second orifice 5 is instead connected in a leakproof manner to a connector of the discharge orifice 9 of the container 1. In this case, the discharge orifice 9 comprises the connector for connecting the hose, line or downstream output device.

In the interior 7 of the container 1, the suction tube 3 furthermore comprises a branch 13 to a third orifice 4. Said third orifice 4 is located in the upper region 12 of the interior 7 of the container 1. It is thus at a distance from the first orifice 10. The distance between the first orifice 10 and the third orifice 4 in particular extends substantially over the entire height of the interior 7 of the container 1. A pressure relief valve 14 is arranged between the branch 13 and the orifice 4.

A pump 2 is furthermore arranged in the interior 7 of the container 1. The pump 2 is in operative connection with the suction tube 3. The plant protection product located in the container 1 is delivered by means of the pump 2 through the suction tube 3 from the first orifice 10 of the suction tube 3 to the second orifice 5 and/or the third orifice 4 of the suction tube 3, as is explained in detail below.

The structure of the exemplary embodiment of the discharge apparatus which comprises an output device 6 connected to the container 1 is explained below with reference to FIG. 3 using circuit symbols:

The liquid plant protection product located in the container 1 is drawn by the pump 2 via the orifice 10 into the suction tube 3. The suction tube 3 may comprise a non-return valve 20 at its lower end which prevents plant protection product from passing back from the suction tube 3 via the orifice 10 into the interior 7 of the container 1. The plant protection product is then delivered by the pump 2. From the pump 2, it arrives at the branch 13, from where it may be delivered towards the second orifice 5 or the third orifice 4.

The plant protection product reaches the third orifice 4 if the pressure exerted by the plant protection product on the pressure relief valve 14 exceeds a specific value which is set at the pressure relief valve 14. In the direction of the second orifice 5, the plant protection product advances from the branch 13 to a non-return valve 21 and a controlled non-return valve 22.

An output device 6 is coupled with the container 1 at the downstream second orifice 5 of the suction tube 3. The output device comprises an inlet orifice 15 which is in fluid connection with the second orifice 5 of the suction tube 3. The plant protection product emerging at the second orifice 5 of the suction tube 3 thus passes via the inlet orifice 15 into the output device 6. A further controlled non-return valve 23 is then arranged at the output device 6. Said non-return valve 23 prevents plant protection product from being able to flow back from the output device 6 into the container 1. Downstream of the controlled non-return valve 23, the output device 6 comprises a 2/2 directional control valve 17. Said valve 17 has a closed and an open state. The states may be changed for example by manual actuation of the output device 6. In the closed state of the valve 17, no plant protection product can pass through the output device 6. In the open state of the valve 17, the plant protection product passes onward to the output orifice 16 of the output device 6. A suitable nozzle for atomizing the plant protection product may be arranged in a manner known per se at the output orifice 16.

The flow of the plant protection product in the closed and the open states of the valve 17 of the output device 6 is explained below:

When the valve 17 is in a closed state and when the pump 2 is in operation, i.e. when it is aspirating the plant protection product from the interior 7 of the container 1 into the suction tube 3 via the first orifice 10, the plant protection product can reach the valve 17. However, due to the delivery of the pump 2, the pressure exerted by the plant protection product 2 on the pressure relief valve 14 then increases. When this pressure exceeds the opening pressure set at the pressure relief valve 14, the pressure relief valve 14 opens and the pump 2 delivers the plant protection product from the lower region 11 of the container 1 via the orifice 10 of the suction tube 3 to the third orifice 4 into the upper region 12 of the container 1. In this way, the plant protection product is circulated in the interior 7 of the container 1. Said circulation homogenizes the plant protection product in the interior 7 of the container 1. In this way, sediment particles are prevented from accumulating in the lower region 11 of the container 1. Such an accumulation would mean that, on discharge of the plant protection product from the container 1, volumes of the plant protection product would initially be discharged which have a higher concentration of sediment particles than subsequently discharged volumes.

When the valve 17 then changes over from the closed state to the open state, for example due to a user having actuated an actuation button of the output device 6, the pressure exerted by the plant protection product on the pressure relief valve 14 drops since the plant protection product passes from the second orifice 5 of the suction tube 3 via the inlet orifice 15 of the output device 6 through the valve 17. This pressure drop causes the pressure relief valve 14 to close. The opening pressure set at the pressure relief valve 14 is selected such that said valve 14 closes when the valve 17 is open and plant protection product is emerging from the output device 6 via the output orifice 16. When the valve 17 is in an open state, the pump 2 thus delivers the plant protection product located in the interior 7 of the container 1 via the first orifice 10 of the suction tube 3 through the suction tube 3 to the second orifice 5, from where the plant protection product passes through the inlet orifice 15 of the output device 6 through the non-return valve 23 and the valve 17 to the output orifice 16, where it is output.

When the valve 17 is changed back over to the closed state by user actuation and the pump 2 continues to run, the plant protection product is once again circulated in the interior 7 of the container 1.

Actuation of the valve 17 may in particular be configured such that the pump 2 is run for a certain amount of time before the valve 17 opens, in order to ensure that, before being discharged, the plant protection product has first been circulated in the interior 7 of the container 1. For example, the valve 17 may only be brought into the open state when the pump 2 is running. Alternatively, when a trigger for the valve 17 is actuated, the pump 2 is first of all switched on and the valve 17 does not change into the open state until a predetermined time interval has elapsed.

FIG. 4 shows a second exemplary embodiment of the discharge apparatus. It differs from the first exemplary embodiment according to FIG. 1 by way of the geometry of the container 1 and also the configuration of the suction tube 3 at the height of the first orifice 10.

The base 8 of the container 1 has a conical shape. As a result, a lowest point 24 is formed at the base 8 of the container 1, at which the plant protection product located in the container 1 collects. Residual quantities of liquid thus accumulate at the lowest point 24 of the container 1. Since, on account of its conically formed base 8, the container 1 cannot stand, it is accommodated in a second container 26, which has a rectangular shape with a flat base.

The suction tube 3 touches the base 8 of the container 1. In order nevertheless to be able to aspirate plant protection product in this case, the suction tube 3 comprises small holes 25 around the lower region, which form the first orifice 10 and through which the plant protection product can pass into the suction tube 3.

However, in the second exemplary embodiment, the suction tube 3 can also be arranged as in the first exemplary embodiment, i.e. not touch the base 8.

FIG. 5 shows a third exemplary embodiment of the discharge apparatus. The third exemplary embodiment differs from the first and second exemplary embodiments by way of the configuration of the container 1, the arrangement of the first orifice 10 relative to the third orifice 4 and optionally the configuration of the suction tube 3 in the lower region.

In this case, the base 8 of the container 1 is formed in an oblique manner such that the plant protection product located in the container 1 collects at the left-hand side of the container 1. Here, too, the base 8 of the container 1 forms a lowest point 24 on the left-hand side. The suction tube 3 is arranged in the container 1 such that the first orifice 10 reaches as close as possible to the lowest point. This means that the rising part of the suction tube 3 is arranged on the left-hand side in the container 1. The branch 13 to the third orifice 4 is configured to be so long that the third orifice 4 ends just in front of the side wall of the container 1 on the right-hand side. However, in this case, the third orifice 4 is still far enough from the side wall that the plant protection product can flow back into the container 1 without being impeded. As a result of this arrangement, the distance between the first orifice 10 and the third orifice 4 extends not only substantially over the entire height of the interior 7 of the container 1, but also across a substantial part of the width of the interior of the container 1. The distance between the two orifices 10 and 4 is thus particularly large.

Since the base 8 of the container in FIG. 5 is oblique, that end of the suction tube that forms the first orifice 10 should be formed in an oblique manner to the same degree, so that the first orifice 10, as in the second exemplary embodiment, can terminate with the base 8 or, as in the first exemplary embodiment, is arranged at a short distance above the base 8. As in the second exemplary embodiment, holes 25 which form the first orifice 10 can be introduced into the lower end of the suction tube 3 in this case, too.

The output device 6 according to FIG. 3 can also be attached to the containers of the second and third exemplary embodiments.

The above-described discharge apparatus is used according to exemplary embodiments of the invention for the above-mentioned plant protection products. In the case of such use, these plant protection products are introduced into the interior 7 of the container 1 and are then atomized as desired by means of the output device 6.

### LIST OF REFERENCE NUMERALS

1 Container
2 Pump
3 Suction tube
4 Third orifice of the suction tube 3
5 Second orifice of the suction tube 3
6 Output device
7 Interior of the container 1
8 Base of the container 1
9 Discharge orifice of the container 1
10 First orifice of the suction tube 3
11 Lower region of the container 1
12 Upper region of the container 1
13 Branch
14 Pressure relief valve
15 Inlet orifice of the output device 6
16 Output orifice of the output device 6
17 2/2 directional control valve
18 Side wall of the container 1
19 Upper wall of the container 1
20 Non-return valve
21 Non-return valve
22 Controlled non-return valve
23 Controlled non-return valve
24 Lowest point of the container
25 Holes in the suction tube
26 Accommodating container

1-14. (canceled)

15. A discharge apparatus for a plant protection product comprising:
a container having an interior for accommodating the plant protection product and comprising a discharge orifice,
a suction tube comprising a first orifice in the interior of the container, a second orifice positioned at the discharge orifice of the container and a third orifice in the interior of the container, the second orifice positioned at a distance from the first orifice, and
a pump in operative connection with the suction tube, wherein the pump is configured to deliver the plant protection from the first orifice of the suction tube to the second and the third orifices of the suction tube.

16. The discharge apparatus of claim 15, wherein the container comprises a base and the first orifice of the suction tube is arranged in the interior of the container in the region of the base of the container.

17. The discharge apparatus of claim 15, wherein the base of the container comprises a lowest point and the first orifice is arranged in the region of the lowest point of the base.

18. The discharge apparatus of claim 15, wherein the third orifice of the suction tube is arranged in an upper region of the container.

19. The discharge apparatus of claim 15, wherein the third orifice of the suction tube is arranged relative to the first orifice such that the first orifice is positioned at a distance apart from the third orifice.

20. The discharge apparatus of claim 15, wherein the third orifice is arranged in the upper third of the height of the container.

21. The discharge apparatus of claim 15, wherein the third orifice is arranged in an upper range of 90% to 100% of the height of the container.

22. The discharge apparatus of claim 15, wherein the suction tube further comprises a branch to the third orifice positioned between the first orifice and the second orifice, and a valve positioned between the branch and the third orifice.

23. The discharge apparatus of claim 15, wherein the discharge apparatus comprises an output device, the output device comprising an inlet orifice and an output orifice, wherein the inlet orifice is connected to the second orifice of the suction tube or to the discharge orifice of the container.

24. The discharge apparatus according to claim 23, wherein a shut-off valve is arranged between the inlet orifice and the output orifice of the output device.

25. The discharge apparatus according to claim 24, wherein when the shut-off valve is closed, the pump aspirates the plant protection product at the first orifice of the suction tube, delivers it through the suction tube and outputs it back into the interior of the container at the third orifice of the suction tube.

26. The discharge apparatus according to claim 24, wherein when the shut-off valve is open, the pump aspirates the plant protection product at the first orifice of the suction tube, delivers it through the suction tube and delivers it into the output device at the second orifice of the suction tube.

27. A method discharging a plant protection product comprising the step of operating the discharge apparatus of claim 15 to discharge the plant protection product from within the interior of the container.

28. The method of claim 27, wherein the plant protection product forms sediments.

29. The method of claim 27, wherein the container comprises a base and the first orifice of the suction tube is arranged in the interior of the container in the region of the base of the container.

30. The method of claim 27, wherein the base of the container comprises a lowest point and the first orifice is arranged in the region of the lowest point of the base.

31. The method of claim 27, wherein the discharge apparatus comprises an output device, the output device comprising an inlet orifice and an output orifice, wherein the inlet orifice is connected to the second orifice of the suction tube or to the discharge orifice of the container.

32. The method of claim 31, wherein a shut-off valve is arranged between the inlet orifice and the output orifice of the output device.

33. The method of claim 32, wherein when the shut-off valve is closed, the pump aspirates the plant protection product at the first orifice of the suction tube, delivers it through the suction tube and outputs it back into the interior of the container at the third orifice of the suction tube.

34. The method of claim 32, wherein when the shut-off valve is open, the pump aspirates the plant protection product at the first orifice of the suction tube, delivers it through the suction tube and delivers it into the output device at the second orifice of the suction tube.
